(19) United States
(12) Patent Application Publication
(10) Pub. No.: US 2005/0010311 A1
(43) Pub. Date: Jan. 13, 2005

(54) Data collection and diagnostic system for a semiconductor fabrication facility

(76) Inventors: Christopher J. Barbazette, Gilroy, CA (US); Daniel J. Fritschen, Sunnyvale, CA (US)

Correspondence Address: O'MELVENY & MYERS, LLP, 275 BATTERY STREET, SUITE 2600, SAN FRANCISCO, CA, 94111-3305, US

(21) Appl. No.: 10/618,313

(22) Filed: Jul. 10, 2003

(51) Int. Cl. G05B 11/01; G05B 15/00; G06F 7/00; G06F 15/16

(52) U.S. Cl. 700/78; 700/20; 709/201; 707/10

(57) ABSTRACT

The present invention provides a data collection and diagnostic system. The system, in one embodiment includes a data acquisition device that receives messages and alarm signals from each automation component controller. The system stores the messages and alarm signals received from each automation component controller and distributes the messages and alarm signals to a user—either locally or remotely. The system includes a configuration tool for selecting which messages and alarms signals are stored in a user accessible database. Multiple users may simultaneously access the information stored on the database or in real time over a network—either by a physical communication line or wirelessly.

### FIELD OF THE INVENTION

The present invention generally relates to an e-Diagnostics and data collection system for a semiconductor fab. More particularly, the present invention comprises a web-based, real-time data collection system that stores and distributes operational information of each front end components within a processing tool.

### BACKGROUND OF THE INVENTION

e-Diagnostics systems increase the availability of production and facilities equipment, reduce mean time to repair (“MTTR”), and significantly reduce field service resources/costs. This capability is preferably available for 200 mm and 300 mm fab equipment, probe/assembly/test equipment and key facilities equipment. e-Diagnostics systems enable equipment supplier's field service personnel to access any key production or facilities equipment from outside the IC maker's facility/factory via a network connection. Access includes the ability to remotely monitor and diagnose problems.

Three metrics of fab performance are die yield, fab yield, and Overall Equipment Effectiveness (OEE). Die yield corresponds to the percentage of semiconductor die per wafer that performs to specification. Many factors can effect the die yield, including surface and airborne contaminants. Standard Mechanical Interface (“SMIF”) technology has introduced a marked improvement in yield by greatly reducing contaminants and particulates around the wafers. Processing tools, however, need to be monitored for contaminants and particle counts to ensure that the environment surrounding the wafers remains relatively contaminant and particle free. Tool and component productivity also significantly effects die yield. Conventional fab maintenance programs do not identify poor tool performance and/or tool failure.

Low OEE often results from poor wafer fab operating procedures. A processing tool, for example, may have a high cycle time causing wafer lots to sit idle in long queues between processing steps. High cycle times have a direct and adverse effect on OEE. If a processing tool has an improved cycle time, bottlenecks in other parts of the wafer fabs may develop and adversely effect OEE.

Many wafer fabs also do not have adequate maintenance programs. The processing tools, for example, only receive periodic tool maintenance. Under this practice, a poorly performing tool may go unnoticed for a significant period of time. Moreover, once a problem is detected, there are likely no on-site technicians with the technical expertise to diagnose and repair the problem. The malfunctioning tool is, therefore, taken off-line until a technician arrives to the processing tool. Thus, the tool may sit off-line for several days.

Processing tools often include a front end interface that houses several front end components. The front end components, working together, transfer the wafers between a SMIF pod and the tool within a substantially particle free working space. By way of example only, a processing tool may include the following front end components: one or more load port assemblies for receiving a SMIF pod, opening the SMIF pod, and presenting the workpieces to the processing tool; a reader that identifies the wafer carrier; one or more aligners for wafer center identification, notch orientation, and indicial mark reading; and a wafer handling robot for transferring the wafers.

Each front end component is electrically coupled directly to a front end component controller. The controller monitors the operation of, and communicates with, the front end component. The processing tool also includes a tool controller that monitors the tool's operation by communicating with each front end component controller and provides this information to, for example, a wafer fab Computer Integrated Manufacturing (“CIM”) System via an Ethernet connection. The information provided to the wafer fab host computer is conventionally via a SECS (SEMI Equipment Communications Standard) serial interface and accessed by a fab operator or maintenance technician.

The information monitored by the tool controller may also be distributed to remote locations (e.g., locations outside the wafer fab) via an Internet-based user interface. The tool controller, however, monitors and/or records very few of the messages sent by the individual front end component controllers. Thus, the diagnostic ability of a conventional data collection system is limited. These systems do not provide an accurate picture of the tool's performance at a tool component level.

There is no standard front end component controller within the semiconductor industry. Each front end component controller in the processing tool may be from a different manufacturer and may communicate by a different protocol that complies with the SECS serial interface standards. Thus, the varying protocols communicated to a fab host computer, and the information collection process, must be coordinated within the wafer fab.

When a processing tool breaks down, it sits idle in the fab until it is repaired. The tool controller will generate a generic error alarm that the processing tool is malfunctioning—it will not indicate why a specific front end component failed. For example, a load port that fails sends an alarm signal and an event message to the tool controller identifying that it is not operating to specification. The tool controller, however, does not record the event message. The fab operator, aware of the failure, typically calls the OEM to report that the processing tool is not operating properly and requests that the OEM repair the processing tool. The OEM, by analyzing the recorded data in the tool controller, will identify that the load port is the malfunctioning piece of equipment. The OEM technician may attempt to repair the load port, but likely does not have access to the data (e.g., the event message) to do so. The technician therefore requests that the load port manufacturer repair the load port. This process may take several days. During this time, the processing tool sits idle.

Although there has been an improvement in detecting faults associated with semiconductor manufacturing processes, one problem currently encountered by the semiconductor manufacturing industry is the delay in locating these faults such that the corrective measures can be implemented in a more expedient manner.

### SUMMARY OF THE INVENTION

One aspect of the present invention is to provide a data collection system that acquires data from each front end component controller. The status of each front end component controller is monitored separately, which provides a greater level of resolution in monitoring the operation of the processing tool. By way of example only, data acquired from each front end component may include (1) component utilization tracking, (2) detailed time stamped operation summary for optimization, (3) detailed, specific alarm and error summary, (4) permanent log of communication between components and controller, (5) monitor components parameters for usage errors related to ware out sending messages before a failure to prevent tool downtime, and (6) independent monitor of productivity AMHS, fab scheduling systems and operator. In another embodiment, the data collection system may also monitor the communications between the front end component controllers.

Another aspect of the present invention is to provide a data collection system that may filter that data acquired from each front end component controller. In one embodiment, the data collection system includes a configuration tool that allows a user to select if the data received from a front end component controller will be saved in a database. In another embodiment, the configuration tool also allows a user to select which data received from the front end component controller may be monitored on a real time basis.

Yet another aspect of the present invention is to provide a modular data collection system that may be installed to monitor a single front end component or be installed throughout the fab. By way of example only, a processing tool may include three load ports, a pre-aligner and a robot. The data acquisition device may monitor one of the front end components (e.g., only one load port) or any combination of the front end components. In one embodiment, the data acquisition device is a passive listening device that is connected between the front end component and the tool controller. Each port of the data acquisition device may be configured to match the protocol of the specific front end component.

Yet another aspect of the present invention is to provide a data collection system that generates reports based on the collected data. The monitoring system, by way of example only, may generate a load port utilization report and an operator productivity report. The load port utilization report provides an operator with information such as useful time on the tool, Pod/FOUP time on the tool, and usage cycles. An operator productivity report provides, for example, time from pod arrival to pod lock and time between pod unlock and pickup.

Yet another aspect of the present invention is to provide a data collection system that stores data for historical purpose and allows a user to view the data from any location that can communicate with the network. In one embodiment, the data collected by the system may be viewed through a Internet enabled interface. In another embodiment, the data collected by the system may be viewed through an off-the-shelf software program, such as Microsoft Office®. In yet another embodiment, the data may be viewed and/or collected through a wireless network. Regardless of the user interface, the collected data may be viewed from a remote location (e.g., outside of the wafer fab or from a host computer).

Still another aspect of the present invention to provide a data collection system that allows on-line collaboration between key personnel. In one embodiment, the data collected from each front end component provides the ability to review and analyze historical or real time data concerning a specific front end component, a specific processing tool, or on a fab-wide level.

Still another aspect of the present invention is to provide a data collection system that enables a fab operator or technician to anticipate when a processing tool will malfunction before the problem occurs. In one embodiment, the data collection system includes a diagnostic tool that generates maintenance reports that provide, for example, the number of cycles until the next preventative maintenance is required, the number of power-up incidents, the number of alarms related to a failure, and the cumulative time processing tool has been in an off-line maintenance mode.

Yet another aspect of the present invention is to provide a data collection system that allows a user to compare similar front end components operating at different processing tools. The ability to compare the operation of similar front end components fab-wide will identify best implementation methodologies and ultimately lead to sharing “best known” automation methods across tools using similar automation components.

### BRIEF DESCRIPTION OF THE DRAWINGS

FIG. 1 is a schematic diagram of the present invention, illustrating the architecture of the data collection system;

FIG. 2 is an illustration of an embodiment of a web page generated in accordance with the present invention, illustrating the status of each processing tool within a fab;

FIG. 3 is an illustration of an embodiment of a web page generated in accordance with the present invention, illustrating a tool performance report;

FIG. 4 is an illustration of an embodiment of a web page generated in accordance with the present invention, illustrating a tool status window.

FIG. 5 is an illustration of an embodiment of a web page generated in accordance with the present invention, illustrating a detailed view of a status window of a load port transfer assembly; and

FIG. 6 is an illustration of an embodiment of a web page generated in accordance with the present invention, illustrating a wafer carrier status window.

### DETAILED DESCRIPTION OF THE INVENTION

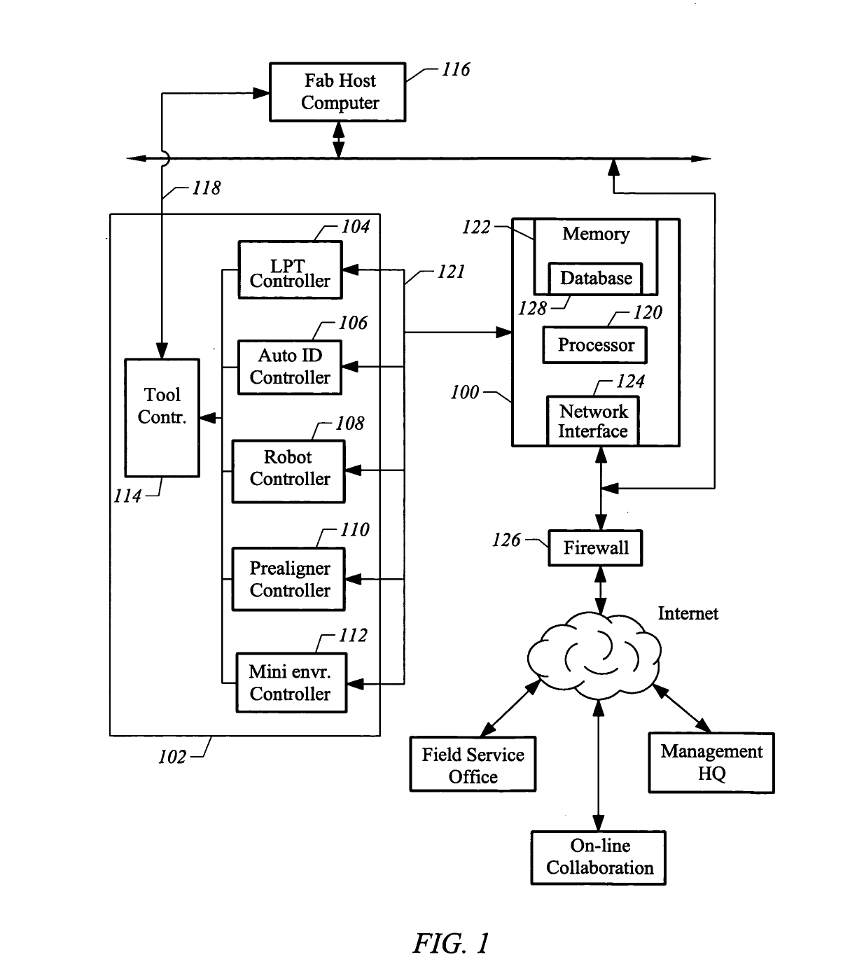

The present invention will now be described with reference to FIGS. 1-6. The present invention relates to a web-based, real-time data collection system. The system processes and distributes the collected information to allow remote diagnostics, maintenance, control and evaluation of various facets of semiconductor equipment and overall semiconductor manufacturing process. The system comprises hardware and software components. The software may be stored on and implemented by various processing devices, including a microprocessor included within an associated tool and serially or in parallel connected to the various front end component controllers within the tool.

Another term to describe the present invention is a remote diagnostics system (“RDS”) or a data collection and diagnostics (“DDC”) system. An RDS gathers the events occurring during the semiconductor fabrication process. The RDS generates messages that enables technical support personnel to diagnose problems within the process tool automation system in case of technical problems. The RDS also helps a field technician analyze and troubleshoot the system. In a preferred embodiment, the RDS supports both SEMI Equipment Communication Standard (“SECS”) messages and ASCII. A user may configure the system to store all or some of the messages. The messages are saved in the database and the same can be viewed using reports. In addition, the RDS helps the field technician take reports of the subsystems deployed at the fab location remotely from a desktop or laptop computer. an RDS also needs to notify the field engineers in case of alarms. In short, an RDS is expected to help in reducing the total troubleshooting cycle time.

The data collection system 100 performs many functions. One function is to gather data from the various automation component controllers (e.g., front end components and AMHS components). The data relates to a wide variety of process parameters, including the status of the individual components, the identification of a wafer lot on the tool, and the performance of the tool, tool components and an operator monitoring the tool. By way of example only, the data comprises event messages, configuration messages, control messages, and alarm signals or codes. For purposes of this application, the term messages may refer to one or more of the event, configuration, or control messages.

Another function of the data collection system 100 is to distribute the data over a network. The data may be distributed through, by way of example only, a local area network or a wide area network (e.g., the Internet). While a variety of platforms are contemplated, the information may be presented as raw data used to populate a centralized server, a specific local tool web page/server, or on a number of tool specific web pages. Each platform is formatted to include information relating to the tool front end components, the tool, the tool operators and/or the semiconductor fabrication process.

Yet another function of the data collection system 100 is to enable remote configuration, diagnostics, maintenance, and updates of the tool components and tools within the fab. A automation component performing below specification may be serviced remotely without having to take the entire tool off-line. Moreover, information relating to the tool components and tools within the fab may be quickly disseminated to any remote location in real time.

The data collection system 100 includes, among other things, a configuration tool, an interactive tool, and a report tool. The configuration tool is one of the many user interface (“UI”) applications of the data collection system 100, by which settings are configured and stored in, for example, an XML format. The configuration tool also allows a user to configure each port of a data acquisition device 101 (described later) and define the protocol of the messages and signals sent from each automation component controller. The configuration tool further allows a user to define which messages from each automation component controller will be stored in a database 128.

The interactive tool allows a user to monitor a specific front end component over an active line. The active line, for example, provides real time monitoring of any automation component that is connected to the data collection system 100.

The report tool allows a user to view, by way of example only, load port utilization, throughput of a fab, throughput of a tool, operator productivity, alarm/error summary, preventative maintenance program, power-up incidents and cumulative power-time and maintenance modes. In one embodiment, these reports are developed using Crystal reports. It is within the scope and spirit of the present invention to generate reports using other software tools. A user may export a snapshot of data collected from a front end component controller to, for example, an Excel® spreadsheet. The data collection system 100 allows a user to select which front end component the user would like to analyze. A user may define a specific period of data to analyze by, for example, selecting a time frame of data to view. In one embodiment, the user, after defining the time frame, clicks a “download” button and an Excels file opens and presents the specified data. This snapshot may be saved for later use.

FIG. 1 illustrates a data collection system 100 fabricated in accordance with one or more embodiments of the present invention. The basic architecture of the data collection system 100 will be described with reference to a single processing tool 102. As shown in FIG. 1, the data collection system 100 includes a data acquisition device 101, a processing tool 102, a fab host computer 116, and a user interface (e.g., the Internet).

The processing tool 102, as shown in FIG. 1, includes a load port controller (“LPT controller”) 104, an auto ID controller 106, a robot controller 108, a pre-aligner controller 110, a mini-environment controller 112, and tool controller 114. Each component controller e.g., LPT controller 104) is embedded or integrated into a respective automation component. For example, the LPT controller 104 is integrated into and communicates with a load port, the robot controller 108 is integrated into and communicates with the a robot, and the like.

The tool controller 114 communicates with all of the front end component controllers (e.g., LPT controller 104, robot controller 108, etc.) in the processing tool 102. A conventional tool controller 114, however, cannot monitor or store all of the messages sent by the front end component controllers. The tool controller 114 monitors the overall operation of the processing tool 102 and receives generic alarm signals that only identify that a front end component has failed. The toll controller 114 does not record why the front end component failed.

The messages and alarm signals sent from each front end component controller are gathered by the data acquisition device 101. In one embodiment, the data collected from each automated front end component (e.g., load port, robot, pre-aligner, auto ID, etc.) includes (1) component utilization tracking, (2) detailed time stamped operation summary for optimization, (3) detailed, specific alarm and error summary, (4) permanent log of communication between components and controller, (5) monitor components parameters for usage errors related to ware out sending messages before a failure to prevent tool downtime, and (6) independent monitor of productivity AMHS, fab scheduling systems and operator.

The data acquisition device 101 preferably includes, among other things, a processor 120, memory 122, a network interface 124 and a database 128. The network interface 124 may be electrically coupled to a LAN and/or a Wide Area Network (“WAN”) such as the Internet, or through a wireless network. If the data acquisition device 101 is accessible through the Internet, a firewall 126 is preferably provided to prevent unauthorized access to the information stored in the database 128.

The data collected from each front end component controller is processed by the processor 120 and is stored in the database 128. Data processed by the processor 120 and stored in the database 128 may be referred to as information. The database 128 may store the information in any number of protocols known within the art that comply with the SEMI SECS communication standard. By way of example only, the data gathered by the data acquisition device 101 may be stored in the database 128 in an Open Database Connectivity (ODBC) or XML format. FIG. 1 illustrates that the database 128 is an integral component of the data acquisition device 101. It is within the score and spirit of the invention for the database 128 to be separated from the data acquisition device 101 (e.g., the database 128 may comprise a server connected to the network downstream of the data acquisition device 101).

For illustrative purposes only, a processing tool 102 includes two load port controllers 104, two auto ID controllers 106, a mini-environment controller 112, a robot controller 108, and one aligner controller 110. Each of these controllers sends, in real time, messages to the data acquisition device 101 that provide the status of each component. In one embodiment, the data acquisition device 101 includes a local memory 122. The local memory 122 temporarily stores the data received from the front end component controllers and functions as a buffer device for the database 128. The processor 120 processes the data while the data is located in the memory 122 according to instructions from the configuration tool. The messages and alarm signals that the data collection system 100 is configured to store are forwarded to the database 128.

The fab host computer 116 may collect the messages and signals from each local memory 122 throughout the fab. It is within the scope and spirit of the invention to monitor the data stored in the memory 122 with a wireless device such as, but not limited to, an PDA. The data acquisition device 101 may also operate without a memory 122. The processor 120 may process the data from the component controllers as the data id received.

Each data acquisition device 101 may simultaneously monitor several automation controllers. The data acquisition device 101 is accessible, by way of example only, through an Ethernet network. If the database 128 is located on a server that is remote from the data acquisition device 101, the data acquisition device 101 populates the database 128 through the Ethernet. The data acquisition device 101 is a passive device that receives communications from each automation component controller. The data acquisition device 101 does not affect the reliability of the processing tool 102. The data acquisition device 101, in a preferred embodiment, preferably has its own dedicated power and communication system that is independent of the processing tool's power and communication system. Thus, if the power supply to the data acquisition device 101 is interrupted, the processing tool's power supply is not. Similarly, the processing tool's communication line is not affected when a communication cable between the data acquisition device 101 and a front end component controller is disconnected.

The data collection system 100 collects the messages and signals sent from the automation component controllers, enabling a fab operator with information to know when an automation component malfunctioned and why it malfunctioned. By way of example only, a front end component controller may provide a shuttle following error message, an excessive wafer out error message, a perimeter sensor trip error message, and a wafer map sensor error message. The data collection system 100 monitors all of the automation component controllers within a semiconductor fab. Examples of error messages are shown below and all relate, for illustrative purposes only, to the operation of a load port assembly.

Shuttle Following Error. A conventional 300 mm load port assembly includes a pod advance plate that advances a FOUP towards and away from the port door. Motion towards the port door is known within the semiconductor industry as “docking” motion and motion away from the port door is known within the semiconductor industry as “undocking” motion.

SMIF pods are loaded either manually or automatedly onto the pod advance plate. Sensors in the pod advance plate send a signal to the tool controller 114 and/or fab host computer 116 to activate the advance plate linear drive and advance the pod toward the port door. An example of a load port assembly is disclosed in U.S. Pat. No. 6,530,736, entitled “SMIF Load Port Interface Including Smart Port Door,” issued to Rosenquist, which is assigned to the owner of the present invention, and is incorporated by reference in its entirety herein.

If an error occurs during the docking and/or undocking motion (e.g., the pod advance plate malfunctions), the pod advance plate will stop immediately. The load port controller 114 will subsequently generate an alarm report along with a corresponding event message (typically indicating the location of the pod advance plate when the error occurred) and send the message to the tool controller 114.

Excessive Wafer Out Error. A conventional load port also includes a sensor system to detect if a wafer is not located properly within the SMIF pod. A sensor in the load port checks, for example, if a wafer is extending out of the pod far enough that the wafer mapping system (described later) will strike the wafer as the wafer mapping system passes by the wafer. In one embodiment, a sensor system within the load port comprises an infra-red (“IR”) transmitter and receiver located central to the port opening in a vertical orientation. When the sensor detects a wafer, the vertical motion of the port door will cease immediately. The load port controller 114 subsequently sends an alarm report, along with a corresponding event message, to the component controller 114.

Perimeter Sensor Trip Error. A load port assembly may also include a perimeter sensor system to sense and adjust the spacing between the port plate and the pod shell as the pod shell approaches the port plate. An example of such perimeter sensor system is discussed in U.S. Pat. No. 6,530,736, entitled “SMIF Load Port Interface Including Smart Port Door,” issued to Rosenquist, which is assigned to the owner of the present invention and is incorporated in its entirety herein.

If a perimeter sensor detects that unintended contact is about to occur between the pod shell and the port plate upon continued advancement of the pod towards the load port, the load port controller 104 will stop the pod from advancing further to prevent potentially harmful contact between the pod and the load port. Similarly, if an error is detected while the SMIF pod is advancing towards the load port (e.g., a perimeter sensor is blocked), the pod advance plate will stop moving immediately. The load port controller 104, in both examples, will generate an alarm report, along with a corresponding event message, to the tool controller 114.

Wafer Map Sensor Failure. A conventional load port often includes a wafer mapping system mounted to the port door. One example of a wafer mapping system is disclosed in U.S. Pat. No. 6,188,323, entitled “Wafer Mapping System,” issued to Rosenquist et al., which is assigned to the owner of the present invention, and is incorporated by reference in its entirety herein.

A wafer mapping system, by way of example only, includes a transmitter assembly. The transmitter assembly includes a transmitter mounted at the end of a first finger and a receiver provided in a second finger. Each finger, in one embodiment, is mounted on an opposing edge of the port door. As the port door is lowered into the processing tool, the first and second fingers are rotated inward to extend within the SMIF pod shell. As the port door continues to be lowered into the processing tool the wafer mapping system detects the presence and position of the wafers within the SMIF pod. This information is typically stored in memory for latter use.

If, for example, the receiver is blocked and cannot receive a signal from the transmitter while the port door is being lowered, the port door will return to its closed position, and the SMIF pod will be returned to a home or undocked position. The load port controller 104 subsequently sends an alarm signal, along with a corresponding event message, to the tool controller 114.

The tool controller 114, as previously discussed above, only monitors the generic alarm signals sent by each automation component controller. The tool controller 114 does not record or monitor the messages or alarm signals sent by the controller. A fab operator, using a central computer that receives signals only from the tool controller 114, is only notified which automation component malfunctioned. The operator cannot determine remotely why the component failed.

In one embodiment, the data acquisition device 101, if it is not integrated into a component controller or the tool controller 114, is connected between the tool controller 114 and a component controller and therefore also receives the alarm signals and event messages. Collecting data in this manner is more reliable because the data collection system 100 does not rely on the tool controller 114. The data collection system 100, utilizing the data acquisition device 101, provides a “bottom up” approach to collecting real time data from each automation component controller. In a conventional fab, there are hundreds of automation component controllers (e.g., front end component controllers and AMHS controllers). The data collection system 100 allows a fab operator to know the status of each automation component in the fab in real time. The data collection system 100 provides several advantages over a “top down” monitoring system, including, but not limited to:

More Data with Better Granularity. The data acquisition device 101 monitors the tool 102 at the component level. The data acquisition device 101, in contrast to the tool controller 114, monitors and records all of the messages and alarm signals sent by the front end component controllers. Accordingly, more detailed information is collected on each front end component. An Asyst load port is capable of generating, for example, several hundred messages and alarm signals that the tool controller 114 does not record or monitor. If the tool controller 114 is configured to, for example, monitor the generic alarm signal from the load port controller 104, the other hundred plus signals generated by the load port controller 104 are ignored and not monitored.

The data acquisition device 101 monitors the LPT controller 104 to identify and verify several functions, including, but not limited to: (1) when a wafer carrier arrives at the load port assembly as indicated by the pod-at-port sensor; (2) when a carrier door is separated from a carrier shell; (3) when the carrier door is again locked into the carrier; and (4) when the carrier is removed from the LPT. The data acquisition device 101 similarly monitors the status of the robot, prealigner, mini-environment and the other front end components in the processing tool.

The data acquisition device 101 also monitors the utilization of the load port transfer assembly as indicated by the LPT controller 104. Load port transfer assembly utilization refers to the amount of time the load port transfer assembly is operating versus the amount of time the load port assembly sits idle. The data acquisition device 101 also receives information regarding the actual cycle time, and the number of workpieces a component processes per hour, per day. This information may be compared to the ideal cycle time for the particular components or comparison against like components in other processing tools.

Predict Tool Maintenance. Collecting this very detailed information through the data acquisition device 101 allows a user to track historical data and identify when a tool's performance is sliding. The user is then able to predict tool malfunctions before they occur. Moreover, in the event of a tool failure, the data collection system 100 is able to identify both the failure and the cause of the failure. As previously discussed above, conventional monitoring systems that communicate directly with the tool controller 114 are able to identify a tool failure, but are unable to identify cause of the failure.

This additional information will also assist a fab operator to predict maintenance across the entire fab. For example, if load ports throughout the fab malfunction soon after a specific alarm is generated by the load port controller 104, a fab operator can shut down the load port immediately after the pre-failure alarm is monitored. Shutting down the component, prior to the actual malfunction, allows the fab operator the opportunity to schedule maintenance for the component. The throughput of the fab will increase because, among other things, a fab operator can redirect SMIF pods after the specific alarm is monitored—preventing a load port from failing while a SMIF pod is docked at the load port.

The information stored in the database 128 may also be used to, by way of example only, provide valuable maintenance or replacement forecasting information, identify components which are broken, have failed, have generated error messages or which are performing outside of acceptable ranges for like components of comparable age, and the entire history of a component, for a broad range of performance characteristics. This promotes optimal yield within the fab in that the optimal average timing for maintenance and/or replacement of the respective components is known. Moreover, defective components may be quickly identified and removed from the fab population. Additionally, the information gathered by the data acquisition device 101 may also identify processing bottlenecks within the fab so that resources may be used to alleviate the bottleneck and improve throughput.

Reduce Mean Time to Repair. The data collection system 100 will also greatly reduce the amount of time a processing tool will sit idle after it malfunctions. A fab operator will be able to identify which specific front end component malfunctioned, instead of receiving a general error signal from the tool controller 114. Receiving an error message directly from a front end component controller will greatly shorten the mean-time-to-repair. For example, if the fab operator is able to identify that the pod advancing plate of the load port malfunctioned, the fab operator can directly contact the load port manufacturer instead of first calling the processing tool OEM—greatly reducing the time the processing tool sits idle.

More Flexibility. The data collection system 100 provides more flexibility than conventional fab monitoring systems. Conventional fab diagnostic systems are often not effective unless a comprehensive, multi-million dollar system is installed to monitor all of the processing tools within the fab. The data collection system 100 is scalable and is effective even when only monitoring a single processing tool 102 within the fab. A fab operator may monitor all the front end components in a single processing tool 102, or on a more micro level, monitor a single front end component (e.g., a wafer handling robot) in the processing tool 102. A fab operator knows which processing tools 102 in the fab are the high throughput or critical tools. The data collection system 100 allows the fab operator to monitor each front end component at the critical areas of the fab more closely than a conventional monitoring system.

The data collection system 100, having a modular architecture, allows a fab operator to shut down a single front-end component while continuing to monitor the other front end components in the tool 102. A processing tool 102 that includes three load ports, for example, cannot be monitored while the tool 102 is shut down for maintenance because the tool controller 114 is also shut down. With the data acquisition device 101, the fab operator can shut down the malfunctioning load port for maintenance and continue to monitor the other front end components in the processing tool 102. Only the communication link between the front end component controller associated with the powered down component and the data acquisition device 101 will be lost.

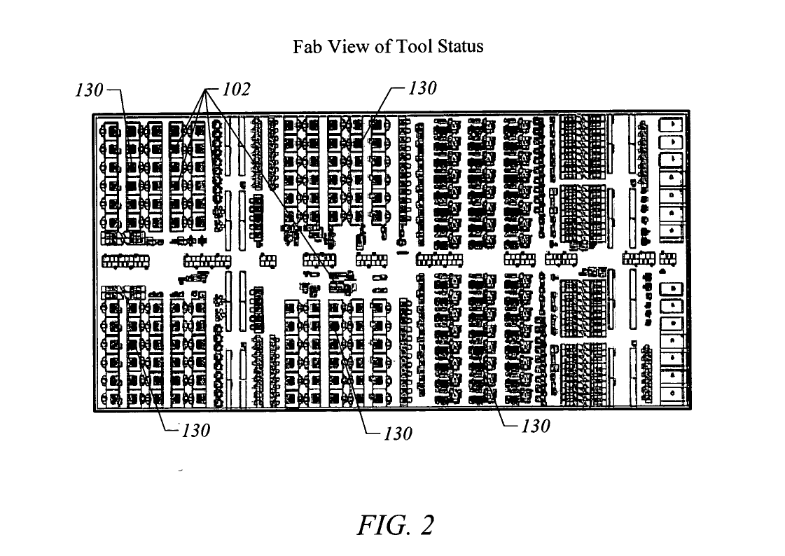

User Friendly Interface. The user interface in the system 100 is preferably a web-based system. In a preferred embodiment, the user interface is accessed through Internet Explorer® Sample web pages including information relating to the status of various tools and front end components within a wafer fab are shown in FIGS. 2-6. FIG. 2 illustrates a web page showing a fab view of each tool 102 within the fab. In a preferred embodiment, a colored dot on a tool (indicated at reference numerals 130) indicates that the tool is not performing to specification. A web page similar to that shown in FIG. 2 may also be configured to demonstrate the areas in the fab having the slowest throughput. Once these slow throughput areas are identified, maintenance and/or additional resources can be provided to these areas to improve the speed at which wafers move through the fabrication process.

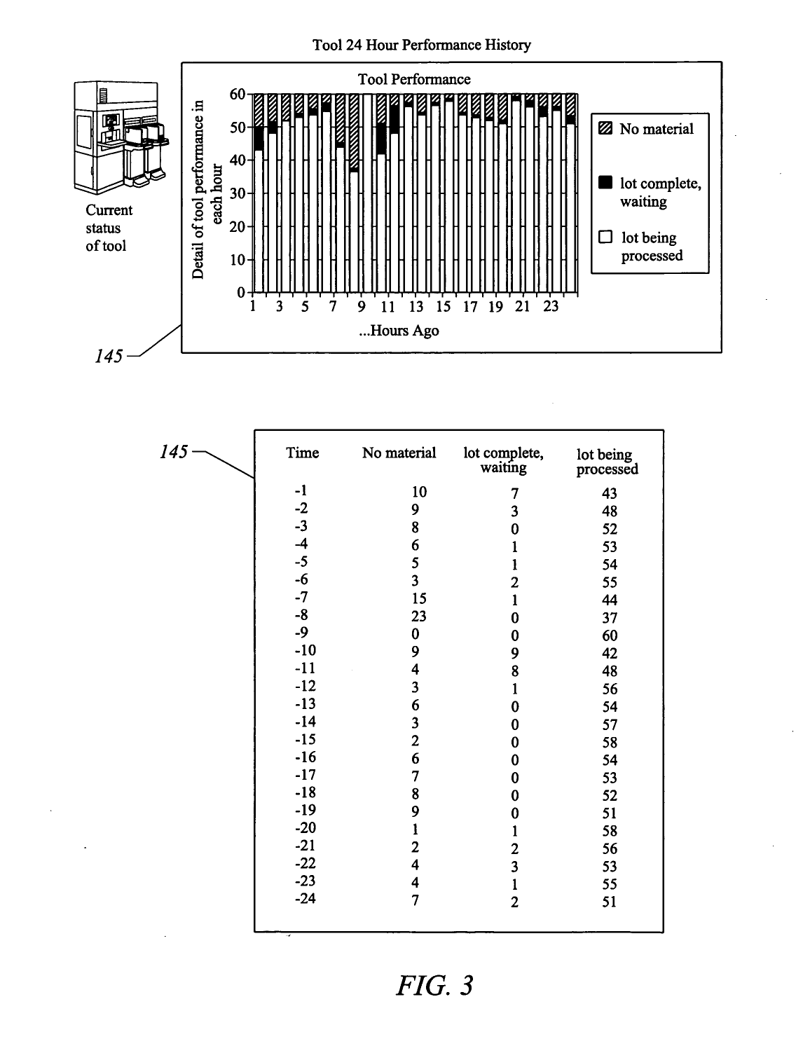

Each representation of a tool shown in FIG. 2 is preferably hyperlinked to another web page. When a specific tool is selected, a new page is generated that shows the tool performance history (see FIG. 3). As shown in FIG. 3, the table provides information about the tool 102 relating to the previous 24 hours of operation and breaks down by hour, for example, how often a wafer lot was being processed by the tool, how often a wafer lot was waiting after processing and how often the tool was sitting idle. Those of skill in the art will appreciate that this information may be expressed in any number of tabular, graphical and alphanumeric interfaces and may display more-or less than 24-hour period.

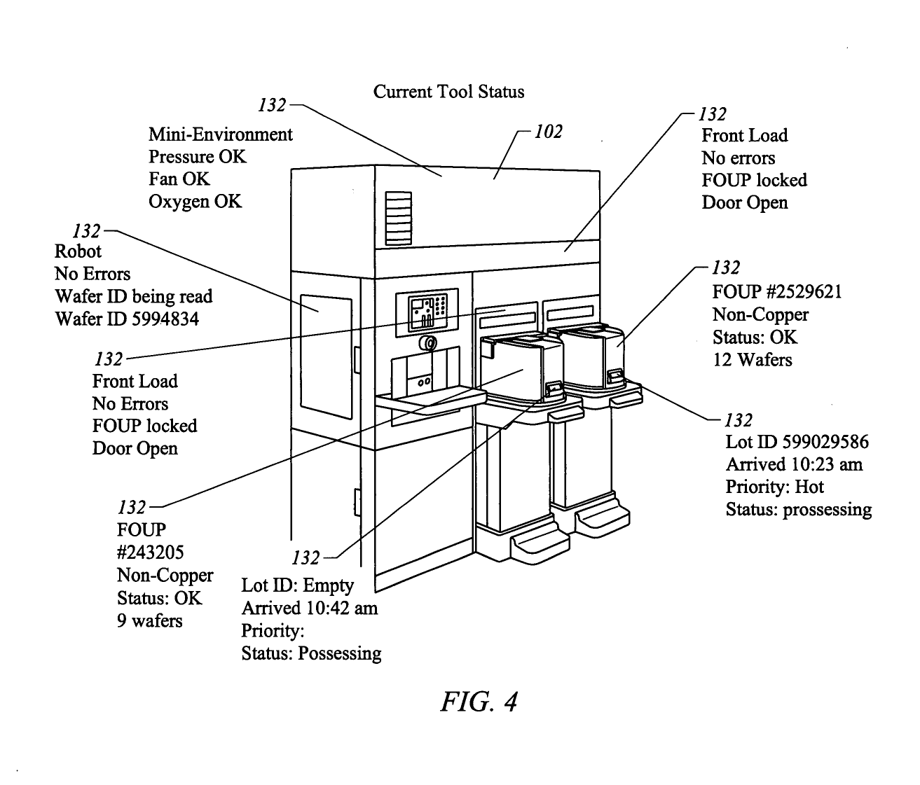

The system 100 enables a user to view more detailed information about the a specific tool shown in FIG. 3. When a tool 102 shown on the screen (as shown in FIG. 3) is selected, a new page is activated showing graphical windows 132 presenting the status of the various components of the tool 102. Such a web page is shown in FIG. 4. The current tool status screen shown in FIG. 4 illustrates, by way of example only, the identity of the FOUP, the operating status of each load port (e.g., no errors, FOUP locked and door open), the operating status of the robot (e.g., no errors, wafer is being read and the wafer ID), and the operating status of the minienvironment (e.g., pressure-ok, fan-ok, oxygen-ok).

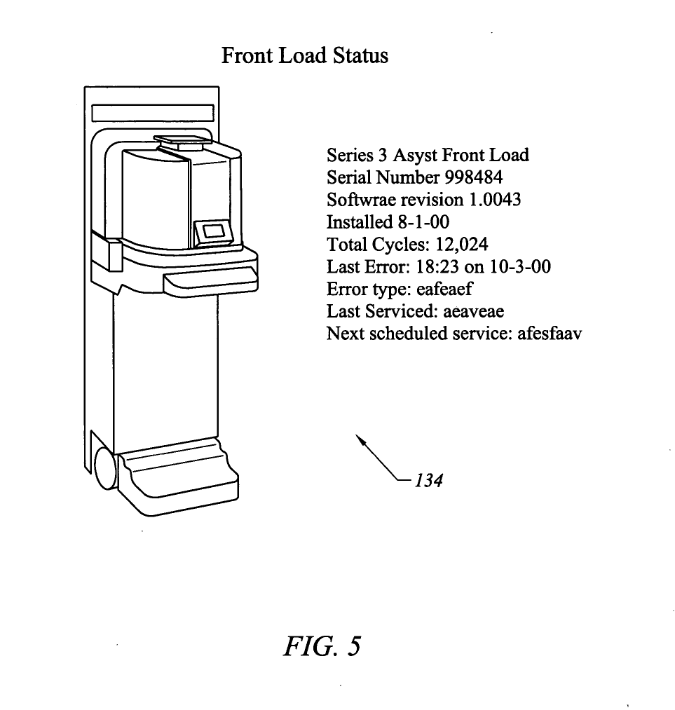

In a further level of resolution, each graphical window 132 on the web page shown in FIG. 4 may include a hyperlink to a more detailed description of the illustrated component and its status. For example, clicking on the window 132 associated with the load port transfer assembly activates a new web page including information 134 about the load port transfer assembly, as shown in FIG. 5. The example shown in FIG. 5 provides, among other things, the model number of the load port (e.g., Series 3 Asyst), the installation date, the total cycles and when the cast error occurred. It is within the spirit and scope of the invention to provide other status information. Similar information concerning the other front end components may also be viewed by selecting the component in FIG. 4.

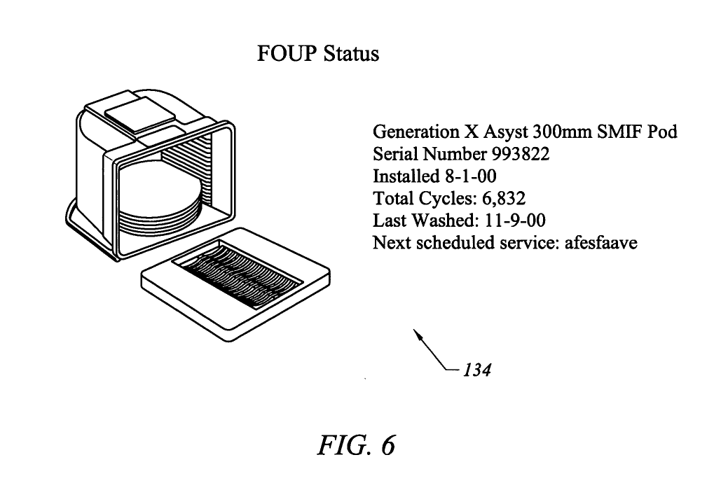

Selecting on the window associated with the wafer carrier, for example, activates a new web page including information 134 about the wafer carrier, as shown in FIG. 6. It is understood that a table, similar to the table of FIG. 3, may be provided as a link for each graphical window in FIG. 4 showing the performance history of the associated component.

The information gathered by the data acquisition device 101 from the individual front end components of the tool 102 may be displayed in a wide variety of other graphical and alphanumeric user interfaces. It is also understood that a wide variety of other reports may be generated, including those relating to one or more performance characteristics for a particular component and/or one or more performance characteristics for the entire component population within the fab. It is understood that the above-described web pages may be accessed remotely through either the Internet or the local area network.

The information stored in the database 128, whether the database 128 is a separate component or integral to the data acquisition device 101, is accessible through the LAN 130. The wafer fab host computer 116, which processes the information to manage carrier flow through the wafer fab, also accesses the database 128 through the LAN 130. When a component controller generates, for example, an error message, the data acquisition device 101 forwards the error message to the wafer fab host computer 116, which may then reroute a SMIF pod away from the tool and/or reschedule lot delivery to the malfunctioning tool.

The tool controller 114 performs this function in a conventional monitoring system. The tool controller 114, however, does not have access to the same resolution of data as the data acquisition device 101. For example, if a load port is malfunctioning, the tool 102 will not recognize it is malfunctioning until a carrier is placed on the load port and the specific function that is malfunctioning is attempted. In contrast, the data acquisition device 101 quickly notifies the host system that the load port is malfunctioning before a SMIF pod is placed on the load port. Reporting a malfunctioning load port prior to dispatching a carrier to the load port saves times and increases throughput of the fab. The information may also be simultaneously sent to other computers located on the LAN for onsite storage, analysis, and maintenance.

One or more embodiments of the data collection system 100 may be used by one person where data collection and analysis is performed on data from one or more fab sites, or by several people where data collection and analysis is performed. In addition, users setting up and/or viewing results may be different users or clients from different parts of the same company, or different users or clients from different parts of different companies, where data is segregated according to security requirements by account administration methods.

The data collection system 100 provides a technician with all the information to diagnose a problem on-line and in real time. The information is gathered by the data acquisition device 101 directly from required each component controller in the tool, allowing the technician to resolve the problem without leaving the field service office. If the field service technician is unable to resolve the problem remotely, the field service technician may collaborate with other technicians and experts on-line, because each technician has real time access to the information directly from the tool component controllers. Thus, analysis of each tool component is faster than if a single technician were in charge.

It is contemplated in accordance with the present invention that a technician may remotely configure a front end component controller. Similarly, a technician may remotely update a tool's configuration as modifications become necessary or desirable. The data acquisition device 101 may also be used to initialize or otherwise write to the carrier IR tag or RF pill from a remote location.

The foregoing description of preferred embodiments of the present invention has been provided for the purposes of illustration and description. It is not intended to be exhaustive or to limit the invention to precise forms disclosed. Obviously, many modifications and variations will be apparent to practitioners skilled in the art. The embodiments were chosen and described in order to best explain the principles of the invention and its practical application, thereby enabling others skilled in the art to understand the invention for various embodiment and with various modifications as are suited to the particular use contemplated. It is intended that the scope of the invention be defined by the following claims and their equivalents.

1. A method for gathering messages and failure codes in a system including a processing tool having a tool controller and a front end component having a front end component controller, the method comprising the steps of:
(a) receiving the messages and failure codes from the front end component controller;
(b) filtering the messages and failure codes according to user defined criteria;
(c) storing the messages and failure codes filtered in said step (c) in a database; and
(d) presenting the messages and failure codes filtered in said step (c) over a network.

2. The method according to claim 1, wherein receiving the messages and failure codes in said step (a) are received from a load port controller.

3. The method according to claim 1, wherein receiving the messages and failure codes in said step (a) are received from an auto ID controller.

4. The method according to claim 1, wherein receiving the messages and failure codes in said step (a) are received from a wafer handling robot controller.

5. The method according to claim 1, wherein receiving the messages and failure codes in said step (a) are received from a pre-aligner controller.

6. The method according to claim 1, wherein receiving the messages and failure codes in said step (a) are received from a minienvironment controller.

7. The method according to claim 1, wherein receiving the messages and failure codes in said step (a) comprises receiving the messages and failure codes in real time.

8. The method according to claim 1, wherein presenting the messages and failure codes in said step (d) comprises presenting the messages and failure codes in real time.

9. The method according to claim 1, wherein presenting the messages and failure codes over a network in said step (e) includes providing access to the network by an Internet browser.

10. The method according to claim 1, wherein presenting the messages and failure codes over a network in said step (e) includes (i) exporting messages and failure codes stored in said step (c) and (ii) generating a report that organizes the exported messages and failure codes into a user readable format.

11. The method according to claim 10, wherein generating a report includes (i) defining which messages and failure codes stored in the database are relevant, (ii) defining a start date and time for the report, (iii) defining an end date and time for the report, (iv) gathering the relevant messages and failure codes from the database that are between the start date and time and the end date and time, and (iv) presenting the gathered messages and failure codes in a readable format.

12. The method according to claim 1, wherein receiving the messages in said step (a) comprises receiving messages selected from a group consisting of (i) event messages, (ii) control messages, and (iii) configuration messages.

13. The method according to claim 1, wherein presenting the messages and failure codes in said step (d) includes presenting the messages and failure codes over a wireless network.

14. The method according to claim 1, wherein filtering the messages in said step (b) includes (i) storing the messages and failure codes temporarily in a local memory, (ii) selecting which messages and failure codes temporarily stored in the local memory will be stored the database, and (iii) forwarding the selected messages to the database.

15. A data collection and diagnostic system, comprising:
a processing tool having a plurality of front end components, each one of said plurality of front end components having a component controller adapted to send messages and alarm signals relating to the operation of said front end component;
a tool controller electrically coupled to each one of said component controllers, said tool controller adapted to monitor some of said messages and alarm signals received form said component controllers;
a data acquisition device electrically coupled to said component controllers, said data acquisition device adapted to monitor all of said messages and alarm signals received from said component controllers, and including:
a processor adapted to filter said messages and alarm signals received from said component controllers;
a database adapted to store said messages and alarm signals filtered by said processor; and
a network interface; and
a central computer electrically coupled to said tool controller and said network interface by a network.

16. The system according to claim 15, wherein said plurality of front end components are selected from a group consisting of (i) a load port assembly, (ii) a wafer handling robot, (iii) a pre-aligner, and (iv) an auto ID system.

17. The system according to claim 15, wherein said component controllers are selected from a group consisting of (i) a load port assembly controller, (ii) an auto ID controller, (iii) a wafer handling robot controller, (iv) a pre-aligner controller, (v) a minienvironment controller, and (vi) an AMHS controller.

18. The system according to claim 15, wherein said network comprises a local area network.

19. The system according to claim 15, wherein said network interface further provides an interface for wireless access to said database.

20. A data collection and diagnostic system, comprising:
a processing tool having a plurality of front end components, each one of said plurality of front end components having a component controller adapted to send messages and alarm signals relating to the operation of said front end component;
a tool controller electrically coupled to each one of said component controllers, said tool controller adapted to monitor some of said messages and alarm signals received form said component controllers;
a data acquisition device electrically coupled to said component controllers, said data acquisition device adapted to monitor all of said messages and alarm signals received from said component controllers, and including:
a processor adapted to filter said messages and alarm signals received from said component controllers; and
a network interface;
a database adapted to store said messages and alarm signals filtered by said processor; and
a central computer electrically coupled to said tool controller, said network interface, and said database by a network.
